(19) United States
(12) Patent Application Publication
(10) Pub. No.: US 2015/0375969 A1
(43) Pub. Date: Dec. 31, 2015

(54) CRANE SYSTEM

(71) Applicant: eepos GmbH, Wiehl (DE)

(72) Inventors: Matthias DICK, Bergneustadt (DE); Timo Koch, Reichshof Alpe (DE); Paul Dick, Gummersbach (DE)

(21) Appl. No.: 14/744,391

(22) Filed: Jun. 19, 2015

(30) Foreign Application Priority Data
Jun. 30, 2014 (DE) 102014109146.9

(51) Int. Cl. B66C 11/00; B66C 9/14; B66C 13/06

(52) U.S. Cl. CPC B66C 11/00; B66C 13/06; B66C 9/14

(57) ABSTRACT

A crane system for transporting and optionally lifting and lowering a load has an elongated beam, a carriage that can move along the beam, a grab on the carriage for picking up and carrying a load, and an electrical drive for displacing the carriage along the beam. A sensor can detect a force applied to the load to move the load relative to the beam. An electronic controller connected between the sensor and the drive can shift the carriage on the beam by the drive in a direction and at a rate comparable to a direction and magnitude of the force applied to the load carried by the pickup means relative to the carriage and/or beam and detected by the sensor means.

### FIELD OF THE INVENTION

The present invention relates to a crane system. More particularly this invention concerns a crane system intended for moving a load close to the ground.

### BACKGROUND OF THE INVENTION

A crane system, for instance used in a shop or warehouse, typically serves for transporting and optionally lifting and lowering a load. It has an elongated movable or stationary beam that extends horizontally and can be attached to a support and a carriage that can move along the beam and that has means for picking up and carrying the load. Displacement of the carriage along the profiled beam is effected by an electrical-motor drive. Such a crane system can also have a beam that can move along spaced and parallel cross members and the carriage that can move along the beam normally at a right angle to the cross members, with another electrical drive for displacement of the carriage along the beam.

Crane systems of this type that pick up loads and transport them in either along one or two axes are well-known in the art and find wide use in practice.

These crane systems are used in a variety of industrial applications. The transport distance of the load to be transported or optionally lifted can range from a few centimeters up to many meters depending on the specific intended use.

The electrical-motor drives of these crane systems in many solutions known from the prior art are controlled by wired or wireless remote controls. The remote controls here each include switches to activate individual functions, such as, for example, forward, backward, left, right, up and down.

A joystick is used in another solution known in the prior art for controlling the electrical-motor drives of the crane system.

The solutions known in the prior art entail the disadvantage that in order to control the electrical-motor drives of the crane system the operator must pick up a control component or operate it at a remove from the load to effect control as intended.

### OBJECTS OF THE INVENTION

It is therefore an object of the present invention to provide an improved crane system.

Another object is the provision of such an improved crane system that overcomes the above-given disadvantages, in particular that where no additional control component is required to control a picked-up load but where control of the electrical-motor drives is effected by the operator's manually moving the picked-up load because the crane system detects the intended direction of the operator and controls the electrical-motor drives accordingly.

According to another object of the invention the crane system aside from detecting the intended control direction must accelerate or brake the load as intended by the operator, thereby enabling the operator to move the picked-up load more quickly and precisely to the intended site and position it there.

### SUMMARY OF THE INVENTION

A crane system for transporting and optionally lifting and lowering a load has according to the invention an elongated beam, a carriage that can move along the beam, a grab on the carriage for picking up and carrying a load, and an electrical drive for displacing the carriage along the beam. A sensor can detect a force applied to the load to move the load relative to the beam. An electronic controller connected between the sensor and the drive can shift the carriage on the beam by the drive in a direction and at a rate comparable to a direction and magnitude of the force applied to the load carried by the pickup means relative to the carriage and/or beam and detected by the sensor means. Thus the direction and the duration of mechanical force pulses produced by an operator when manually moving a picked-up load and are converted to control signals to control the electrical-motor drive in accordance with the detected and converted force pulses.

The force detector and converter according to the invention enables an operator to produce a displacement and deflection of the picked-up load along the path in the intended direction of displacement. In other words, the force pickup and conversion unit can pick up the mechanical pulses of the operator and convert these to corresponding control commands to control the electrical-motor drive and send these to this drive. As a result, the operator only has to push the load in the intended direction, thereby creating a force pulse that is detected by the sensor of the force detector and converter and is then transferred into a control command to the electrical-motor drive of the crane system. The displacement path of the operator thus produces a force pulse which is detected by the sensor and the electrical-motor control, then converted to control the drive according to the intended direction, speed, and intended travel distance. As a result, the operator can control the intended displacement direction as well as the displacement speed and displacement travel distance by simply pushing the load. The invention thus enables especially quick and precise positioning of the load toward and at the intended location since the picked-up load always follows the intended displacement direction of the operator. As a result, no additional control elements need to be actuated by the operator in order to control the picked-up load in the displacement direction.

In particular, the force detector and converter can include two plates that are approximately congruent in the rest position, that are oriented essentially horizontally parallel to the ground when in use, that are held against each other by a straight-line guide system and can move in a straight line relative to each other in a parallel plane, between which or on which the sensor and the electronic controller are provided, wherein the electronic controller is provided near or on the sensor, and the sensor is composed of a magnet provided approximately at the center of the first plate over the longitudinal extent of the plate and a contact rail provided on the second plate, along which the magnet slides when the plates are moved in a straight line.

The sensor of the force detector and converter is composed of a magnet running along a contact rail, as a result of which when a picked-up load is moved by the operator the first plate is moved in a straight line relative to the second plate and the magnet is moved along the contact rail in to the intended operating direction, the displacement path of the magnet along the contact rail being detected in terms of length and transferred by the electronic controller of the force detector and converter in a corresponding control command to the electrical-motor drive of the carriage, with the result that the latter is moved by the electric drive as a result according to the operator's displacement of the picked-up load. As a result, the carriage together with the picked-up load follows the displacement direction that is determined by the operator by manually pushing the load. If, for example, the operator no longer applies manual pressure to the picked-up load, the sensor detects this and sends a command to stop the electrical-motor drives through the control to the drives. If the user, for example, applies only slightly more pressure on the picked-up load, this is interpreted as a control command for moving the carriage slowly in the intended direction and transmitted to the electrical-motor drive. As a result, by applying force to the picked-up load the operator can determine the displacement direction as well as the speed of the intended displacement and the path. The arrangement of two approximately parallel plates that can be held against each other by a linear guide system and moved parallel to each other also allows the use of greater loads, for example, a 500-kg picked-up load in a crane system according to the invention.

In addition, provision can especially preferably be made whereby the linear guide system is composed of a guide rail or multiple guide rails provided on one plate and guide slots provided on the other plate and receiving the guide rail or rails.

This approach also enables relatively high loads to be carried by a crane system comprising a force detector and converter according to the invention.

Provision can furthermore especially preferably be made whereby spring and/or damping elements are provided between the plates that cushion or dampen the linear displacement of the plates and limit the linear displacement path, which elements hold the plates in their approximately congruent position when in the rest position.

The arrangement of appropriate spring elements and/or damping elements, in particular, enables any unwanted large relative displacement of the plates to be damped or cushioned in the case of heavy picked-up loads, thereby allowing the displacement path to be precisely converted to control signals to control the electronic drives.

In terms of damping means, provision can especially preferably be made whereby on one plate a gas-pressure damper with gas pressure cylinder is attached, and a longitudinally movable piston rod is attached opposite the gas pressure cylinder, the free end of the piston rod resting on a stop provided on the other plate.

This type of damping means can prevent faulty operation from pulse peaks both during acceleration and braking since the plates can only move at a slow speed relative to each other due to the damping means. Alternatively, the damping means can also include a pressurized gas cylinder comprising two piston rods projecting from the gas pressure cylinder on both free ends from which the piston rods project and each engage on a stop provided on the other plate, thereby allowing a linear motion to be damped in both directions by the gas-pressure damper.

Provision can furthermore especially preferably be made whereby a first abutment is provided on a plate near the center of the plate, and an additional abutment is provided on the other plate respectively near the front and rear lateral outer edges of the plate in the linear displacement direction, a spring element or a helical spring being provided between the first abutment and each additional abutment, a holding pin being provided on the first and/or additional abutment as the guide means for the spring element or the helical spring.

Spring elements or helical springs provided in this way also prevent any unintended and thus imprecise, excessively fast displacement by the first plate relative to the second plate, thereby as much as possible preventing the sensor from misinterpreting the force pulses of the operator. As a result, the plates have to be pushed against the force of a spring, thereby ensuring that pulse peaks during initial displacement by the operator are precluded as much as possible.

In addition, spring elements or helical springs provided in this way also function to return the plates that were moved relative to each other when in use back to the approximately congruent rest position. To this end both spring elements or helical springs have approximately the same spring force.

Provision can also especially preferably be made whereby a travel limit stop is provided on the first and/or additional abutments, or on each holding pin.

Provision can be especially preferably made whereby the travel limit stop is composed of an elastic material, for example, rubber.

This aspect in particular largely prevents any damage to parts of the force detector and converter when the maximum displacement travel is reached for the plates relative to each other.

Provision can furthermore especially preferably be made whereby the force detector and converter is provided directly on or indirectly close to the carriage.

For example, an additional load pickup means can be attached such as, for example, a pulley or motor-driven cable hoist or chain hoist that enables the load to be transported to be lifted and lowered.

Alternatively, provision can especially preferably be made whereby a rigid shaft is provided between carriage and load pickup means, the force detector and converter being provided between the load pickup means and the shaft.

Provision can especially preferably be made here whereby the rigid shaft is composed of telescoping shaft.

Arrangement of a telescoping shaft between the carriage and the load pickup means first of all enables the force detector and converter to be located close to the picked-up load to be transported, and second enables the picked-up load to be lifted quickly and easily by controlling the corresponding function on the telescoping shaft.

Provision can furthermore especially preferably be made whereby the plates are square or rectangular in shape.

Given the above-referenced object of the invention for a crane system for transporting and optionally lifting and lowering a load, composed of a beam that can move along relatively spaced, parallel cross members and a carriage that can move along the beam comprising means for picking up and carrying a load, displacement of the carriage along the beam and displacement of the beam along the parallel cross members being effected by electrical-motor drives, the invention proposes an approach for achieving this object whereby two force detector and converters rotated 90° relative to each other, optionally comprising the above-referenced features, are either following each other or connected to each other as a common unit, are provided on the crane system between carriage and load pickup means, the one force detector and converter controlling the electrical-motor drive along the cross members and the other force detector and converter controlling the electrical-motor drive along the beam.

A force detector and converter according to the invention can also be used in a crane system comprising a beam that can move along cross members, whereby two force detector and converters rotated 90° relative to each other are combined. The first force detector and converter here functions to control the crane system longitudinally while the second force detector and converter functions to control the crane system transversely. As a result, by the operator's simply moving and thus generating force pulses a picked-up load can move both longitudinally and also transversely, forward and backward respectively, as intended by the operator without the aid additional control devices such as, for example, a remote control.

### BRIEF DESCRIPTION OF THE DRAWING

The above and other objects, features, and advantages will become more readily apparent from the following description, reference being made to the accompanying drawing in which:

FIG. 1 is an isometric view from below of a first embodiment of a crane system according to the invention comprising a beam, electrical-motor drive, and force detector and converter;

FIG. 2 is a front-end view of the force detector and converter of FIG. 1;

FIG. 3 is a side view of the structure of FIG. 2;

FIG. 4 is an isometric view from below of the structure of FIGS. 2 and 3;

FIG. 5 is an exploded isometric view from above of the invention;

FIG. 6 is a detail of a force detector and converter according to the invention as viewed at an angle from above;

FIG. 7 is another detail as viewed at an angle from below;

FIG. 8 is another detail as viewed at an angle from above; and

FIG. 9 is a combination of two force detector and converters rotated 90° relative to each other without an intermediate plate.

### SPECIFIC DESCRIPTION OF THE INVENTION

As seen in FIG. 1 a crane system 1 for transporting and optionally lifting and lowering a load has a stationary or movable beam 2 that can be attached to supports, and a carriage 3 that can move along the beam 2. Displacement of the carriage 3 along the beam 2 is effected by an electrical-motor drive 4. According to the invention, a force detector and converter 6 is provided between the carriage 3 and load pickup means 5. In order to control the electric drive 4, the force detector/converter 6 is connected to this drive. The connection is made by unillustrated cables. The force detector/converter 6 includes a sensor 7 for detecting the mechanical force pulses for displacement direction, speed, and path, which pulses are produced by an operator when manually moving a picked-up load. In addition, the force detector/converter 6 includes an electronic controller that converts the detected force pulses to control signals to control the electric drive 4 in accordance with the detected and converted force pulses.

This electronic controller also includes an evaluation unit that evaluates the force pulses detected by the sensor before converting them into control signals.

The arrangement of this type of the detector/converter 6 between the carriage 3 and load pickup means 5 enables an operator to control the electrical-motor-driven motion of the carriage 3 by simply pushing the picked-up load. Pushing the load by the operator thereby determines both the direction and the length of the displacement path as well as the displacement speed. The operator can thus control the crane system by pushing the picked-up load. If the operator ceases to produce force pulses in the displacement direction, this is detected by the sensor of the force detector/converter 6 and the motor-driven displacement of the carriage is braked or stopped. The electrical-motor-driven carriage in this type of controlled crane system thus follows the load virtually unnoticed. The force detector/converter 6 detects all force pulses produced by the operator and converts these accordingly into control commands to control the electric drive 4. As a result, this type of force detector/converter 6 is able to produce a displacement and/or deflection of a picked-up load from the detected path of the push.

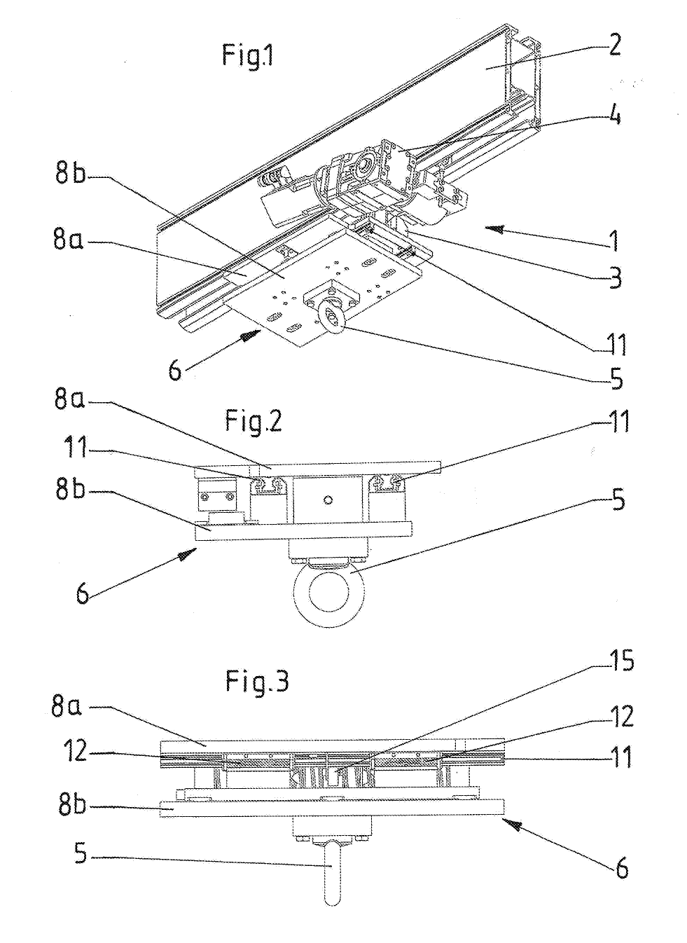

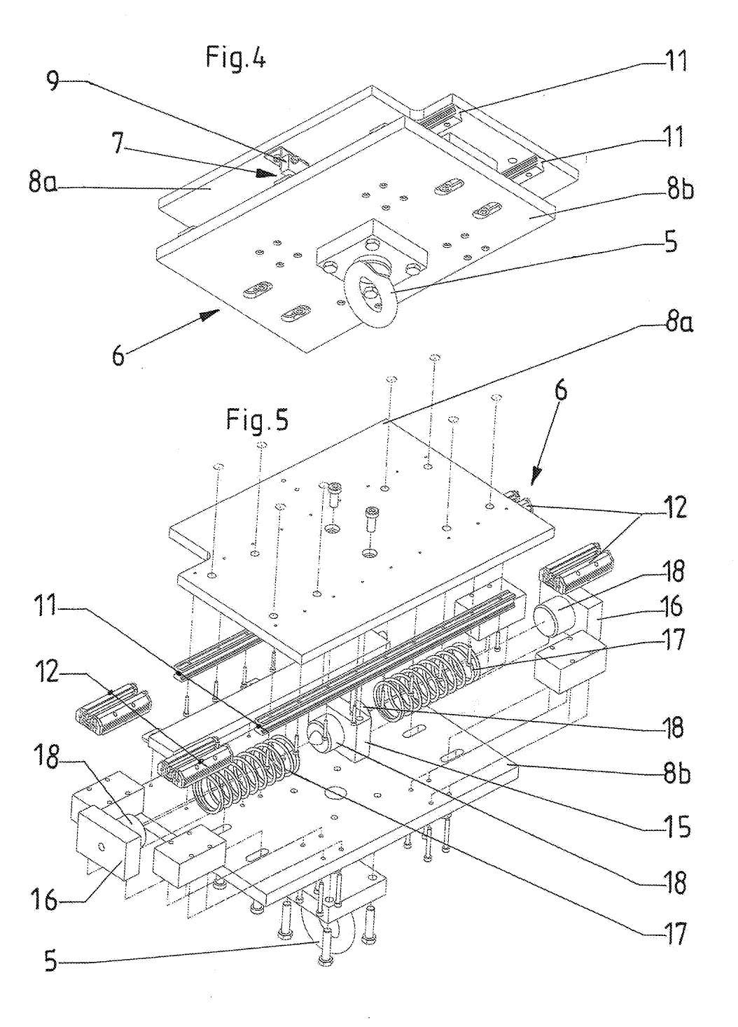

As shown especially clearly in FIGS. 1 through 6, first the crane 1 according to the invention includes the force detector/converter 6, composed of two plates 8a and 8b that are approximately congruent to each other in the rest position. The plates 8a and 8b are oriented approximately horizontally parallel to the ground when in use. The plates 8a and 8b are held against each other and can move in a straight line and parallel to each other in a plane via a linear guide system. Two parallel straight-line guide systems are provided between the plates 8a and 8b in the embodiment. The sensor 7 is also provided between the plates 8a and 8b and the electronic controller. The electronic controller in the embodiment is part of the sensor 7. The sensor 7 is composed of a magnet 9 provided on the first plate 8a approximately at the longitudinal center of the first plate 8a and a contact rail 10 provided on the second plate 8b. When the plate 8a is moved in a straight line relative to the plate 8b, the magnet 9 moves along the contact rail 10, thereby enabling the displacement path and the displacement direction to be detected and then separated by the electronic controller into control signals for the electric drive 4.

FIGS. 5 through 8 show that the straight-line guide system is composed of guide rails 11 provided on the first plate 8a and engaging guide elements 12 provided on the second plate 8b, and on which the guide rails 11 are respectively guided.

The arrangement can also be implemented in an alternative approach not shown in the figures in that guide rails 11 are provided on the second plate 8b and the guide elements 12 are provided on the first plate 8a.

The arrangement of these straight-line guides enables high loads to be picked up in the crane 1 of this type. These straight-line guides furthermore only allow the plates to be moved unidirectionally relative to each other.

Spring and/or damping elements are provided between the plates 8a and 8b in order to prevent unintended large displacement by the plates 8a and 8b relative to each other, for example, when the load is initially pushed by the operator. The spring and/or damping elements cushion the relative straight-line displacement of the plates 8a and 8b, or dampen the straight-line displacement path and limit this during displacement. In addition, the spring and/or damping elements hold the plates 8a and 8b in the congruent rest position thereof, or return these to the rest position after use.

Depending on the intended application of the crane 1, it is possible to use both spring elements as well as damping elements, or also only spring elements or only damping elements, on the force detector/converter 6 of the crane 1 according to the invention.

As shown especially clearly in FIG. 8, a gas-pressure damper 13 is attached to plate 8b and has a cylinder 13a and a piston rod 13b that is longitudinally movable relative to the gas pressure cylinder 13a. The free end of piston rod 13b rests on a stop 14 provided on the second plate 8a. Alternatively, the gas-pressure damper 13 comprising the gas pressure cylinder 13a and the piston rod 13b can also be provided on the plate 8a, while the stop 14 can be provided on the plate 8b, or the gas-pressure damper 13 can have pistons rods 13b projecting from both ends.

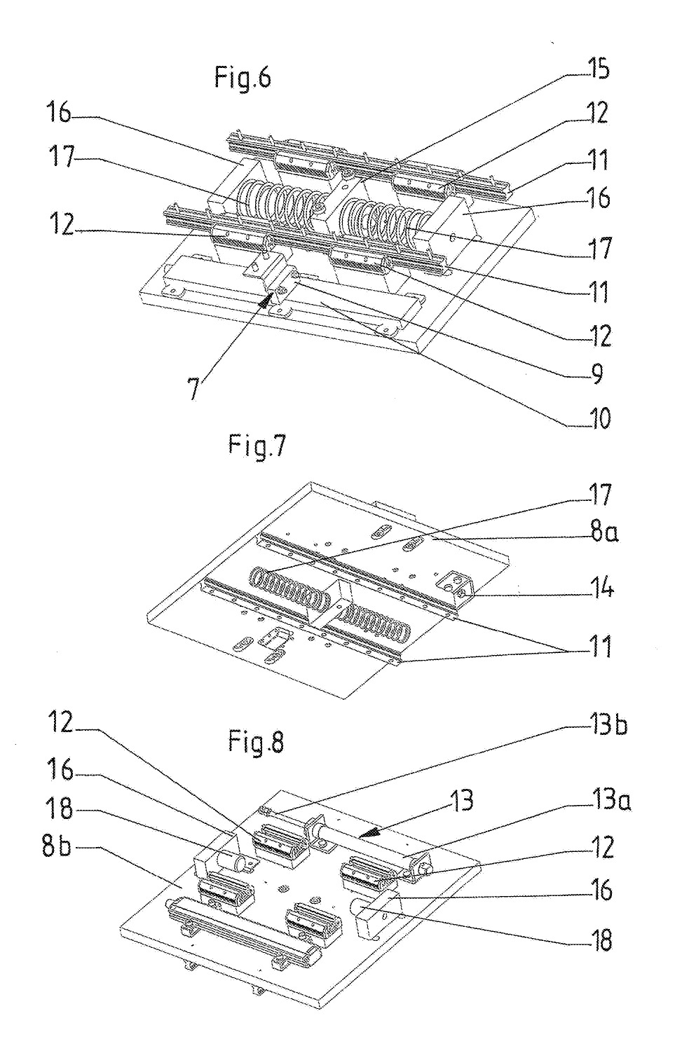

As shown especially clearly in FIGS. 5 and 6, a first abutment 15 is provided near the center of the plate 8a on this plate 8a, and another abutment 16 is provided on the second plate 8b near the front and rear outer lateral edge of this plate in the straight-line displacement direction thereof. A helical spring 17 is provided between each first abutment 15 and the respective other abutment 16. In addition, a holding pin 18 is provided on each of the abutments 15, 16 as guide means for the is respective helical spring 17. This type of arrangement enables the second plate 8b to move relative to the first plate 8a against the force of a spring. This arrangement of helical springs 17 furthermore ensures that the plates 8a and 8b are returned to their approximately congruent position when not in use.

A travel limit stop 19 is composed of an elastic material, rubber in the embodiment, so as to prevent any damage when it is bumped.

The force detector/converter 6 according to the invention can be provided directly on or indirectly close to the carriage 3 of the crane 1 according to the invention. An additional means for lifting and lowering the load can thereby be attached, for example, to the load pickup means 5. This can be, for example, a pulley, or an electrical-motor-driven chain or cable hoist.

Alternatively, a rigid shaft can be provided between the carriage 3 and load pickup means 5. The force detector/converter 6 is then provided between the load pickup means 5 and the rigid shaft. The preferred approach here is to use a motor-driven telescoping shaft as the rigid shaft. The operator then produces the action of lifting or lowering the load directly at the load by means of the motor-driven telescoping shaft, then produces a force pulse by manually pushing the load in the intended displacement direction, which pulse is detected by the sensor 7 of the force detector/converter 6 and sent by the electronic controller of the force detector/converter 6 as a control signal to the electric drive 4 of the carriage 3.

The plates 8a and 8b in the embodiments are square. Alternatively, other shapes such as, for example, a rectangular shape, can be used.

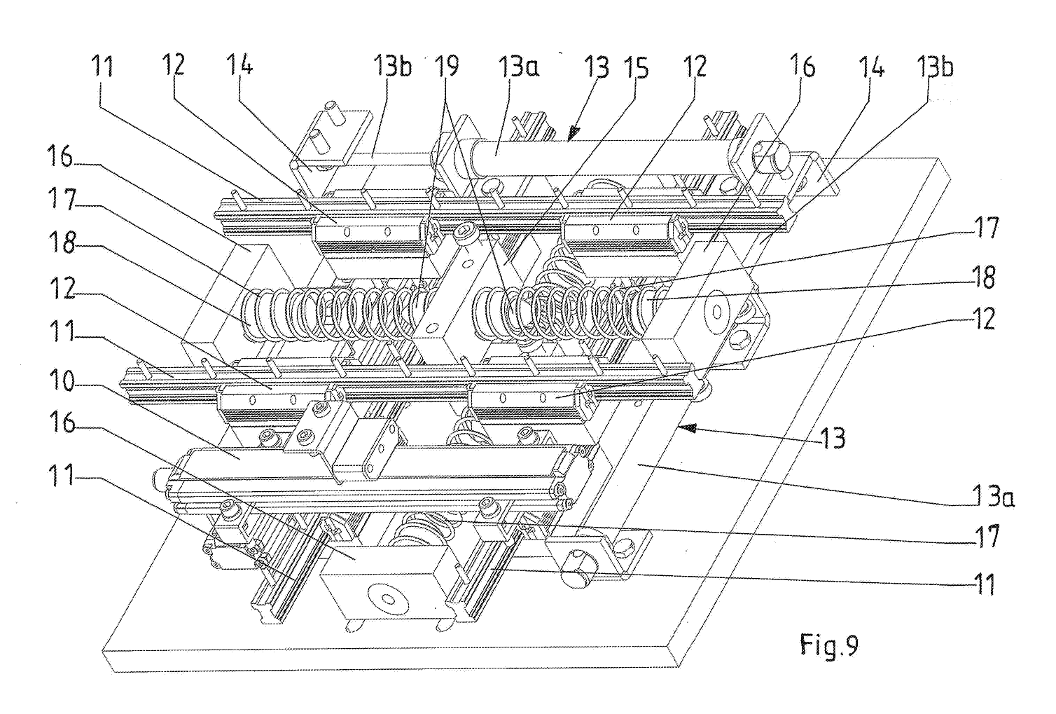

For a crane system for transporting and optionally lifting and lowering a load and composed of the beam 2 that can move along relatively spaced, parallel cross members and the carriage 3 that can move along the beam 2 and that has means for picking up and carrying a load, displacement of the carriage 3 along the beam 2 and displacement of the beam 2 along the parallel cross members being effected by electrical-motor drives, two force detector and converters 6 being used that are rotated 90° relative to each other, as shown in particular in FIG. 9, either following each other or connected to each other as a common unit, and these units can be provided on the crane system between the carriage 3 and load pickup means 5. This combination of two force detector and converters 6 rotated 90° relative to each other enables the drive of the crane system to be provided by an electrical motor, both along the cross members as well as along the beam 2. This approach thus enables control of the crane system to be provided in two axes also simultaneously control follows the force pulses of an operator by simple pushing. FIG. 9 shows the combination of two force detector and converters 6 according to the invention. The intermediate plate provided in practice between both of the force detector and converters 6 is not shown in FIG. 9 for clarity since this plate would obscure these components.

This type of the force detector/converter 6 according to the invention enables the straight-line displacement of a picked-up load to be effected quickly and easily by the operator's pushing the load. The combination of two force detector and converters 6 rotated 90° relative to each other enables the operator to move the picked-up load in two axes by simply pushing the load in the intended direction.

The invention is not restricted to the embodiments but can be varied in multiple ways within the scope of the invention.

All individual and combined features in the description and/or drawing are considered essential to the invention.

We claim:

1. A crane system for transporting and optionally lifting and lowering a load, the system comprising:
an elongated beam;
a carriage that can move along the beam;
means on the carriage for picking up and carrying a load;
an electrical drive for displacing the carriage along the beam;
sensor means for detecting a force applied to the load to move the load relative to the beam;
electronic control means connected between the sensor means and the drive for shifting the carriage on the beam by the drive in a direction and at a rate comparable to a direction and magnitude of the force applied to the load carried by the pickup means relative to the carriage and/or beam and detected by the sensor means.

2. The crane system defined in claim 1, wherein the sensor means includes:
a first plate fixed to the carriage;
a second plate carrying the pickup means;
a straight-line guide assembly connected between the first and second plates and limiting movement of the second plate relative to the first plate to straight-line displacement in opposite directions from a central rest position; and
a sensor connected between the plates for detecting relative straight displacement thereof.

3. The crane system defined in claim 2, wherein the sensor includes:
a magnet on one of the plates; and
a contact rail extending in the directions, on the other of the plates, and juxtaposed with the magnet.

4. The crane system defined in claim 2, wherein the guide assembly comprises:
at least one rail on one of the plates, extending in the directions, and projecting toward the other of the plates; and
a guide element on the other of the plates, receiving the rail, and limiting relative movement of the two plates to straight-line displacement parallel to the directions.

5. The crane system defined in claim 2, further comprising:
spring damping means between the plates urging them into the central rest position.

6. The crane system defined in claim 5, wherein the plates are congruent and aligned with one another in the rest position.

7. The crane system defined in claim 5, wherein the spring damping means includes a gas-pressure damper carried on one of the plates and having a piston rod engageable with a stop on the other of the plates at least in an end position offset from the central rest position.

8. The crane system defined in claim 5, further comprising:
at least one abutment on one of the plates engageable with the other of the plates for preventing movement in one of the directions after travel in the one direction out of the rest position.

9. The crane system defined in claim 5, wherein the spring damping means includes:
a central abutment centrally mounted on one of the plates and projecting toward the other of the plates;
two outer abutments spaced apart in the directions, mounted on the other of the plates, projecting toward the one plate, and flanking the central abutment; and
respective outer springs each braced in the directions between a respective one of the outer abutments and the central abutment.

10. The crane system defined in claim 9 wherein the outer abutments form travel limits for the plates.

11. The crane system defined in claim 10, wherein the outer abutments have pins carrying the respective springs and functioning as the travel limits.

12. The crane system defined in claim 9, wherein the travel limits are formed of an elastic material.

13. The crane system defined in claim 1, wherein the force detector and converter is provided directly on or indirectly close to the carriage.

14. The crane system defined in claim 1, further comprising:
a rigid shaft between the carriage and load pickup means, the force detector and converter being provided with the load pickup means and the shaft.

15. The crane system defined in claim 14, wherein the rigid shaft telescopes.

16. The crane system defined in claim 1, wherein the plates are square or rectangular.

17. The crane system defined in claim 1, further comprising:
at least one cross member extending transversely of the beam and defining a transverse direction generally perpendicular to a longitudinal direction defined by the beam, the beam being moved in the transverse direction on the cross member;
another electrical drive for displacing the beam in the transverse direction on the cross member;
another sensor means for detecting a force applied to the load to move the load relative to the beam in the transverse direction; and
electronic control means connected between the other sensor means and the other drive for shifting the carriage on the beam by the drive in the transverse direction and at a rate comparable to a direction and magnitude of the force applied in the transverse direction to the load carried by the pickup means relative to the carriage and/or beam and detected by the other sensor means.
